(19) United States
(12) Patent Application Publication
(10) Pub. No.: US 2006/0173903 A1
(43) Pub. Date: Aug. 3, 2006

(54) Methods and apparatus to automatically generate claim charts

(76) Inventors: Mark C. Zimmerman, Arlington Heights, IL (US); Michael J. Erpenbeck, Gurnee, IL (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/240,011

(22) Filed: Sep. 30, 2005

Related U.S. Application Data
(60) Provisional application No. 60/615,042, filed on Sep. 30, 2004.

(51) Int. Cl. G06F 7/00

(52) U.S. Cl. 707/102

(57) ABSTRACT

Methods and apparatus to automatically generate claim charts are disclosed. An illustrated method includes receiving an input identifying a patent via a user interface; and automatically generating a claim chart containing at least one claim of the identified patent.

### RELATED APPLICATION

This patent claims priority from U.S. Provisional Application Ser. No. 60/615,042, which was filed on Sep. 30, 2004, and which is hereby incorporated herein by reference.

### FIELD OF THE DISCLOSURE

This disclosure relates generally to patent law, and, more particularly, to methods and apparatus to automatically generate claim charts.

### BACKGROUND

For many years, patent attorneys and/or their assistants have prepared claim charts comparing the elements of one or more claims of a patent (e.g., a United States patent issued by the United States Patent & Trademark Office) to, for example, a method, apparatus, etc. accused of infringing that patent. Frequently, such claim charts are prepared in a two column table format, with the elements of the patent claim at issue parsed into boxes in the left hand column and the allegedly corresponding portions (e.g., structures or processes) of the accused method, apparatus, etc. described in the boxes in the right hand column. In other words, the cells of the left and right hand columns are aligned such that the patent terms in the left hand boxes are generally aligned on a horizontal plane with the allegedly corresponding portions of the accused device, method, etc. described in the immediately adjacent right hand cells.

In addition to being used in support of non-infringement and/or infringement analysis as described above, claim charts are often frequently used in support of validity and/or invalidity analysis. Indeed, claim charts have frequently been used in invalidity opinions, patentability opinions, infringement opinions, non-infringement opinions, letters notifying third parties of infringement, reexamination proceedings before the USPTO, and/or patent enforcement actions before United States Courts.

Claim chart preparation has traditionally involved considerable time and effort. Typically, to create a claim chart, a patent attorney and/or an assistant to a patent attorney creates a table using, for example, a word processing program (e.g., Microsoft Word, etc.). The patent attorney and/or his/her assistant then manually types and/or manually cuts and pastes the language of the claim(s) of interest into the boxes of the table to create a claim chart. Thus, the traditional process of preparing a claim chart has often been tedious, time consuming and subject to human error.

### BRIEF DESCRIPTION OF THE DRAWINGS

FIG. 1 is an example apparatus to generate patent claim charts.

FIG. 2 is a schematic illustration of two example patent claims and an example claim chart generated by the example apparatus of FIG. 1 for the illustrated example claims.

FIG. 3 is an example patent overview chart generated by the example apparatus of FIG. 1.

FIG. 4 is a schematic illustration of an example manner of implementing the example apparatus of FIG. 1.

FIG. 5 is a screen shot illustrating an example interface for the example apparatus of FIG. 1 partially overlayed with an example output from the example apparatus of FIG. 1.

FIGS. 6-8 are flowcharts representative of example machine readable instructions that may be executed to implement the example apparatus of FIG. 1.

FIG. 9 is a schematic illustration of an example processor platform that may implement the client of FIG. 4 and/or execute the machine readable instructions represented by FIGS. 6-8 to implement the apparatus of FIG. 1.

### DETAILED DESCRIPTION

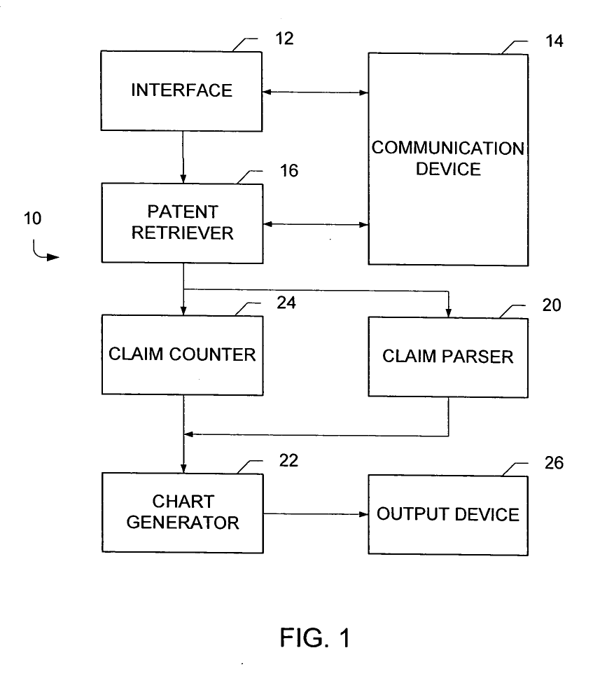

An example apparatus 10 for automatically generating a claim chart is illustrated in FIG. 1. The example apparatus of FIG. 1 is constructed to respond to an input identifying a patent by automatically generating a claim chart containing at least one claim of the identified patent. As used herein, the term “claim chart,” refers to a table, a chart, and/or a diagram of any configuration or shape that represents the text of a claim of a patent divided into two or more portions. The portions may correspond to one or more claim elements, one or more claim limitations, the preamble, the body, or any other useful division for presenting the text of a patent claim in a claim chart.

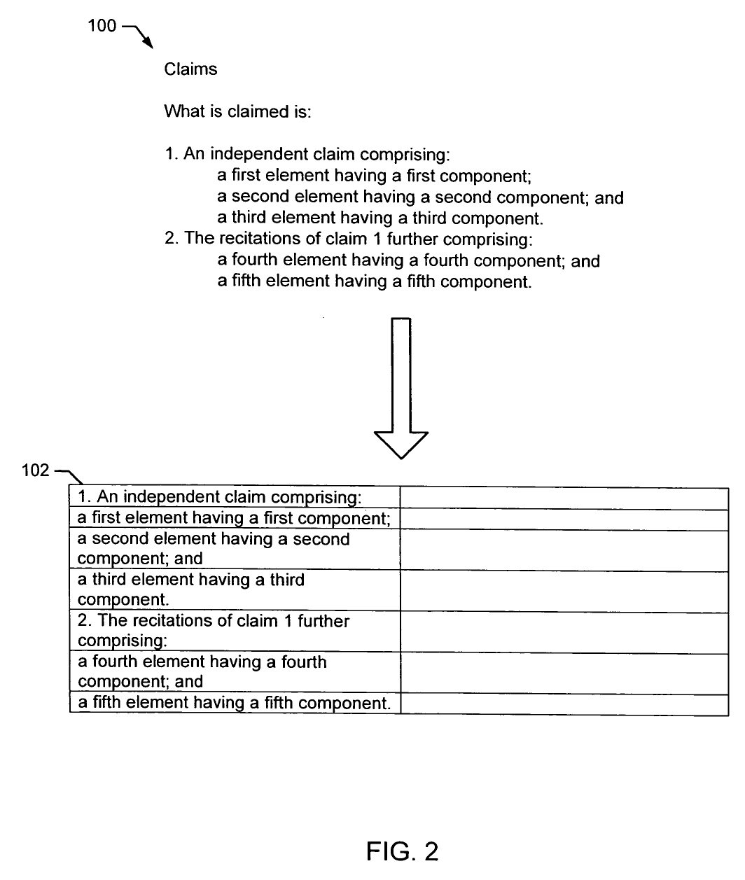

FIG. 2 illustrates an example set of claims 100 and an example table style claim chart 102 generated by the example apparatus 10 of FIG. 1 for the example set of claims 100. In the example of FIG. 2, each portion of the example claims 100 of FIG. 2 is displayed in a separate cell of the first column of the claim chart 102. The second column of the claim chart of the illustrated example is left blank to allow a user to enter relevant information (e.g., corresponding elements shown in a prior art patent to demonstrate the invalidity of the claims 100 or the corresponding elements of an accused apparatus to demonstrate infringement of the claims 100).

For the purpose of receiving one or more inputs from a user, the example apparatus 10 of FIG. 1 is provided with a user interface 12. The example interface 12 of FIG. 1 can be implemented in any desired fashion. For example, the interface 12 may be implemented as an Intranet and/or Internet accessible web page with one or more fields for accepting one or more user inputs. Alternatively, the interface 12 may be implemented as a local interface that is not intended to be accessible via the Internet.

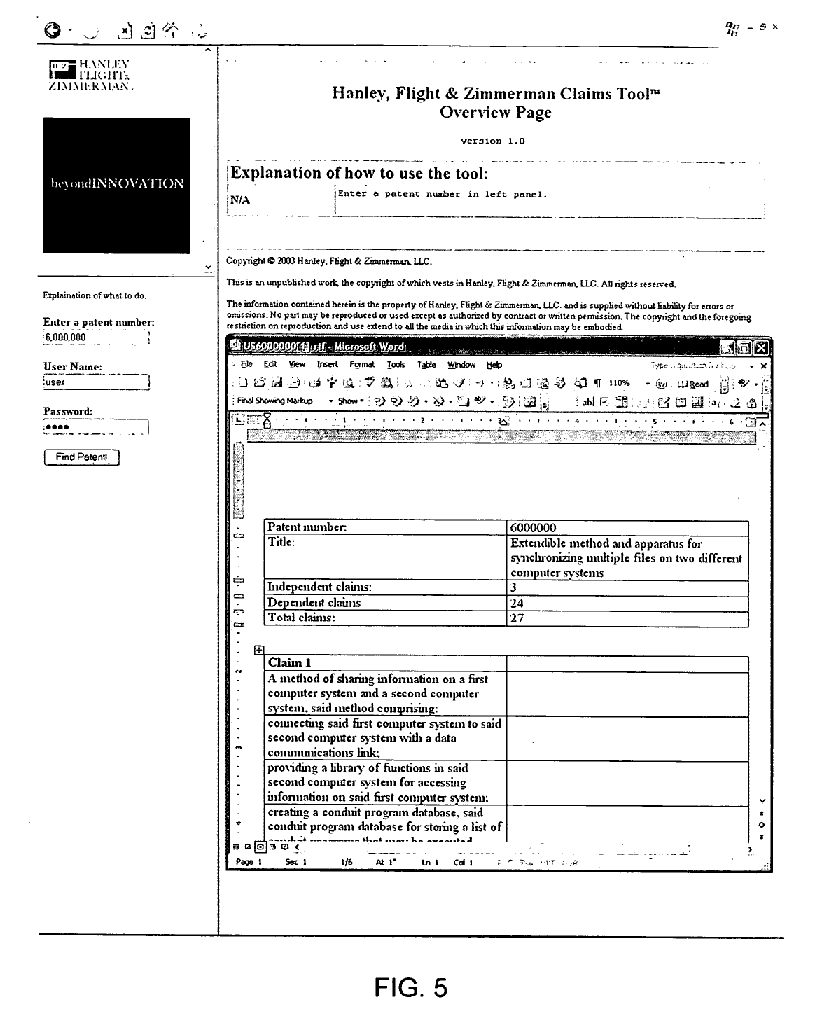

An example interface 12 is shown in FIG. 5. In the example interface 12 of FIG. 5, the interface 12 is constructed as an HTML-based web page that includes three input fields. The first input field is structured to receive a patent number (e.g., a United States patent Number such as 6,000,000). The second and third input fields provide password protection such that only users that enter an acceptable user name and password can cause the apparatus 10 to generate a claim chart. Although the example interface 12 of FIG. 5 is password protected, persons of ordinary skill in the art will readily appreciate that, in some circumstances, password protection might not be desirable and, thus, could be removed or otherwise not enabled. Thus, although three input fields are shown in FIG. 5, other examples may include other numbers of input fields (e.g., only one input field to, for example, receive a patent number, two input fields, etc.)

In the example of FIG. 2, the user interface 12 is communicatively coupled to a communication device 14. The communication device 14 may be implemented in any desired fashion. For example, the communication device can be a bus, a modem, a switch, a network communication card, a server, or any other device(s) that enables the apparatus 10 to accept inputs from a user. In the illustrated example, the communication device is preferably implemented by a modem that permits a client device executing software to implement the apparatus 10 to communicate with one or more other networked devices.

In order to retrieve a patent identified by a user from a database, the apparatus 10 is further provided with a patent retriever 16. The example patent retriever 16 of FIG. 1 is responsive to an identifier of a patent input via the interface 12 to generate a query to access a database. The database is preferably a database of files containing the text of patents (e.g., United States patents). The database may be local to the apparatus 10 or may be remote from the apparatus 10. For example, the database of the apparatus 10 may be implemented as the searchable on-line patent database currently provided by the United States Patent & Trademark Office at the universal resource locator (URL) http://www.uspto.gov/patft/index.html. However, persons of ordinary skill in the art will readily appreciate that any other commercial (e.g., the patent databases provided by Westlaw, Lexis and/or Delphion), public (e.g., the patent databases provided by the European Patent Office) and/or private database of patents may additionally or alternatively be employed.

As shown in FIG. 1, the patent retriever 16 of the illustrated example is communicatively coupled to the communication device 14. Thus, in the example of FIG. 1, the patent retriever 16 formulates a query (e.g., an SQL query) containing the patent identifier (e.g., a patent number) received via the interface 12 and forwards the query to the database. Preferably, the database returns a text file containing at least the claims of the patent corresponding to the patent identifier.

For the purpose of dividing the claim(s) of the patent retrieved by the patent retriever 16 into two or more segments, the example apparatus 10 of FIG. 1 is further provided with a claim parser 20. The claim parser 20 is structured to process at least a portion of the file retrieved by the patent retriever to identify segments of the claims to be placed in separate sections (e.g., cells) of a claim chart. For example, the claim parser 20 may be structured to identify the preamble of a claim, the body of a claim, one or more claim limitations of a claim and/or one or more claim elements of a claim.

In the illustrated example, the claim parser 20 is structured to identify the segments of the claim by searching the claim text for one or more predetermined tokens. Specifically, the illustrated claim parser 20 is structured to compare the words of a claim to the tokens “;”, “; and” and “comprising:”. The tokens “;” and “; and” are used by the claim parser as demarcations between two or more claim segments (each containing one or more claim limitation and/or claim element) because patent claims frequently use semicolons to separate claim elements and patent claims frequently use a semicolon followed by the word “and” to separate the last claim element from the penultimate claim element. The token “comprising:” is used by the claim parser 20 as a demarcation between two or more claim segments because claims frequently use the word comprising followed by a colon to separate the preamble of a claim from the body of a claim. Persons of ordinary skill in the art will readily appreciate that other tokens may likewise be employed by the claim parser 20. For example, the claim parser may use any of the following as tokens to separate or otherwise demarcate claim segments: “,”, “of:” “:”, “consisting of:”, “steps of” and/or any other character combination that is used to demarcate segments of claims (e.g., phrases, claim elements, claim limitations, preamble, body, etc.).

In order to create a claim chart containing the segments identified by the claim parser 20, the apparatus 10 is further provided with a chart generator 22. The chart generator 22 prepares a table or other chart form containing one or more cells or other fields, divisions, containers, etc. For instance, the chart generator 22 of the illustrated example generates a table having two columns such as the example table 102 shown in FIG. 2. The chart generator 22 receives the segments of the claim identified by the claim parser 20 and places each segment in a cell, field, division, container, etc of the generated chart. For instance, in the example of FIG. 2, the chart generator 22 places each segment of the claim identified by the claim parser 20 in a respective one of the cells of the right hand column of the example table 102. Preferably, the segments are placed in cells in a predetermined order. For instance, in the illustrated example, the segments are placed in cells from top to bottom of the table 120 in the order in which the cells appear in the claim or claims 100 being processed. Although the above description speaks in terms of the chart (e.g., table 102) being first created and then populated with the claim segments, persons of ordinary skill in the art will readily appreciate that the creation of the chart may be substantially contemporaneous with the population of the chart with the claim segments.

In order to create a patent overview chart reflecting statistics of interest concerning the patent identified by the input received via the interface 12, the apparatus is further provided with a claim counter 24. The claim counter 24 of the illustrated example counts or otherwise determines the total number of claims in the patent being processed. The claim counter 24 of the illustrated example also identifies the number of dependent claims and the number of independent claims in the patent being processed. The claim counter 24 passes this information to the chart generator 22 (e.g., by placing the information in a memory location accessible to the chart generator 22 or forwarding a message containing the information to the chart generator 22).

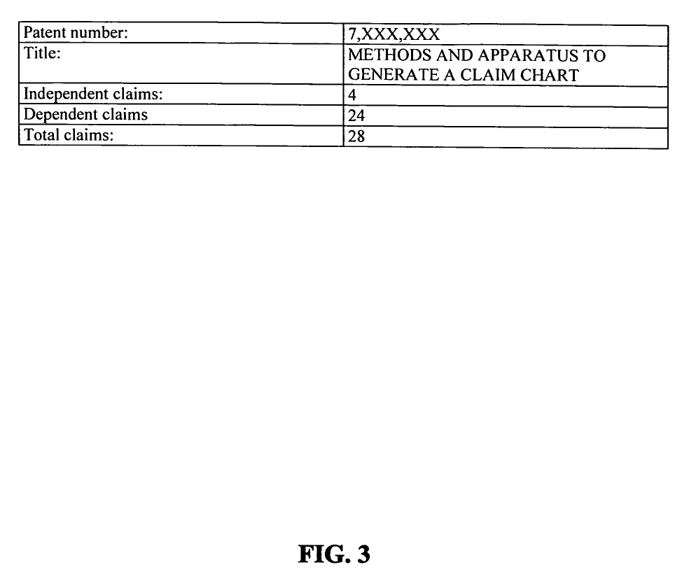

In the illustrated example, the chart generator 22 uses the data generated by the claim counter 24 and other data from the patent being processed to create a patent overview chart such as the example chart shown in FIG. 3. The example patent overview chart of FIG. 3 is a two column table identifying the patent number and title of the patent identified by the input received via the interface 12. The example table of FIG. 3 also identifies the number of independent claims, the number of dependent claims and the total number of claims (i.e., the sum of the number of independent and the number of dependent claims) of the patent. Persons of ordinary skill in the art will appreciate, however, that other forms of charts, and/or different and/or additional data may likewise be appropriate for the patent overview chart.

For the purpose of outputting the claim chart and/or the patent summary chart, the example apparatus 10 of FIG. 2 is further provided with an output device 26. The example output device may be implemented by any type of output device such as a monitor (e.g., a cathode ray tube monitor, a liquid crystal display monitor, a plasma display screen, etc.), a television, a printer, a display of a portable electronic device (e.g., a cell phone, a personal digital assistant, an IPOD), etc. Further, although in the illustrated example, the apparatus 10 includes a local output device 26, persons of ordinary skill in the art may readily appreciate that the output device 26 may be remote and/or not associated with the apparatus. For example, the output device 26 may be associated with a user that accesses the apparatus 10 via an intranet and/or the Internet. In such implementations, the chart generator 22 is preferably coupled to the communication device 14 or to another transmission device that enables transfer of the claim chart created by the chart generator 22 to a remote device.

Preferably, the patent overview chart and the claim chart is automatically generated by the apparatus 10 upon a user entering a patent identifier (e.g., a US patent number) and entering an input (e.g., selecting a graphical representation of a button with a user input device such as mouse or keyboard) to initiate the process. For instance, in the example shown in FIG. 5, the user need only enter a patent number in a patent number field and select a graphical representation of a button labeled “Find Patent!”, to cause the apparatus 10 to respond by creating and outputting a patent overview chart such as the chart shown in FIG. 5 and a patent claim chart for all of the claims of the identified patent. The top of an example claim chart generated in this manner is shown under the patent overview chart in FIG. 5.

Although for compactness of illustration, an example patent overview chart and an example claim chart art shown partially overlying the example graphical user interface of FIG. 5, it is presently preferred that the apparatus 10 output the patent overview chart and the claim chart as an RTF file displayed in a word processing program such as Microsoft Word. Such an approach ensures that the claim chart is presented to the user in a format that is immediately ready for editing to, for example, sub-divide the segments of the claim into one or more additional sub-segments, and/or populate the right hand column of the claim chart with desired data (e.g., data demonstrating the invalidity of one or more claims of the patent and/or data demonstrating infringement of one or more claims of the patent).

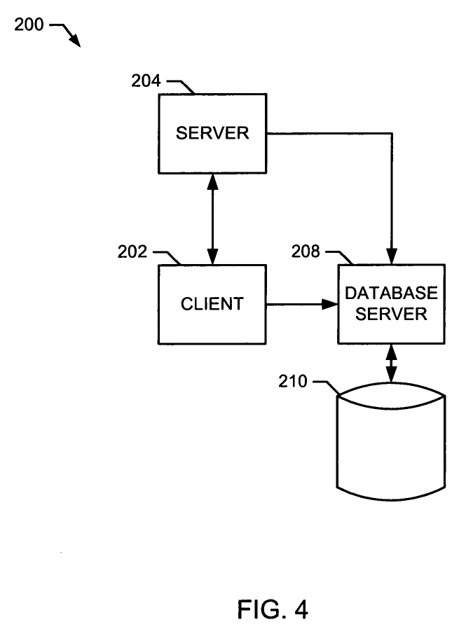

FIG. 4 depicts an example client-server system 200 that may be used to implement the apparatus 10 of FIG. 1 to generate a claim chart. The illustrated example system 200 includes a client 202, a server 204, a database server 208 and a patent database 210. In the example of FIG. 4, the apparatus 10 is implemented by a software program executing on the client 202 and/or executing on one or more of the servers 204, 208.

The client 202 may be implemented by any system capable of connecting to a local server 204 and/or a remote server 208. For example, the client 202 may be a processor platform such as a personal computer, or portable electronic device (e.g., a cell phone, a personal digital assistant, etc.) executing an internet web browser (e.g., Netscape, Microsoft Internet Explorer, Mozilla FireFox, etc.) and/or a dedicated client application (e.g., an application written in Java, C++, VisualBasic, Perl, etc.). The client 202 may alternatively be implemented by a terminal system (e.g., dumb terminal, telnet session, etc.) or any other capable system. The client 202 may directly or indirectly connect to the server(s) 204, 208, transmit user instructions to the server 204, 208, and/or receive one or more responses from the server(s) 204, 208.

The client 202 may use any method to provide the claim chart to the user. For example, the client may allow the user to download the claim chart to some media (e.g., to a local memory device such as RAM, a hard disk drive, etc.), to display the claim chart on a screen of a display device, and/or to print the claim chart to a local or network printer. The client may include the output device 26 discussed above with FIG. 1. Further, some or all of the other components of the example apparatus 10 of FIG. 1 may be implemented by the client 202.

The server 204 may be implemented by any type of server that may communicate with a client 202, with a database 210, and/or with a database server 208. In some example implementations, the interface 12, the communication device 14, the patent retriever 16, the claim counter 24, the claim parser 20 and/or the chart generator 22 of the apparatus 10 of FIG. 1 are implemented by the server 204. In such examples, the sever 204 may receive a request from the client 202 to display a claim chart for a patent. In response to such a request, the server 204 of the illustrated example requests the patent from the database server 208. The database server 208 then connects to a database 210 and retrieves the requested patent data. The database server 208 and database 210 may be, for example, the United States Patent and Trademark Office (USPTO) “Patent Full-Text and Image Database” server available over the Internet. The database server 208 then transmits the data to the server 204. In the example wherein the server 204 implements the interface 12, the communication device 14, the patent retriever 16, the claim counter 24, the claim parser 20 and/or the chart generator 22 of the apparatus 10 of FIG. 1, the server 204 manipulates the data to place it in a claim chart. In implementations wherein the chart generator 22 and perhaps other portions of the apparatus 10 are implemented by the client 202, the server 204 may simply retransmit the data received from the database 210 (e.g., via the sever 208) to the client 202. In the latter examples, the server 204 preferably does not change the retrieved data.

Alternatively, the server 204 may be eliminated from the system 200. In such examples, the client 202 is configured to connect directly to the database server 208. In these examples, the client 202 may implement some or all of the example apparatus 10 of FIG. 1, and/or the database server 208 may implement some or all of the example apparatus of FIG. 1. For example, the database server 208 may respond to requests for a patent by transmitting the requested patent data directly to the client 202, which implements the apparatus 10 and, thus, processes the patent data to create a claim chart as described above. Alternatively or additionally, the database server 208 may implement the apparatus 10 and, thus, may respond to a request from the client 202 by creating a claim chart as explained above and returning the created claim chart to the client 202. Therefore, either the client 202 or the server 208 may be configured to manipulate the patent data for displaying, downloading or printing a claim chart and/or a patent overview chart.

Persons of ordinary skill in the art will recognize that many variations of the system 200 are possible. For example, the database 210 may be local to the client 202 and/or to the server 204. When the database is local to the client 202, the client 202 is configured to retrieve patent data from the database 210 and to manipulate the data to provide a claim chart to the user. Associating a local database 210 with the client 202 allows the client 202 to operate with or without a network connection. In examples wherein the database 210 is local to the server 204, the server 204 is configured to retrieve patent data from the database. The server 204 may manipulate the data to create a claim chart and/or a patent overview chart, and/or the server 204 may transmit the data to the client 202 such that the client 202 can manipulate the data to create a claim chart and/or a patent overview chart.

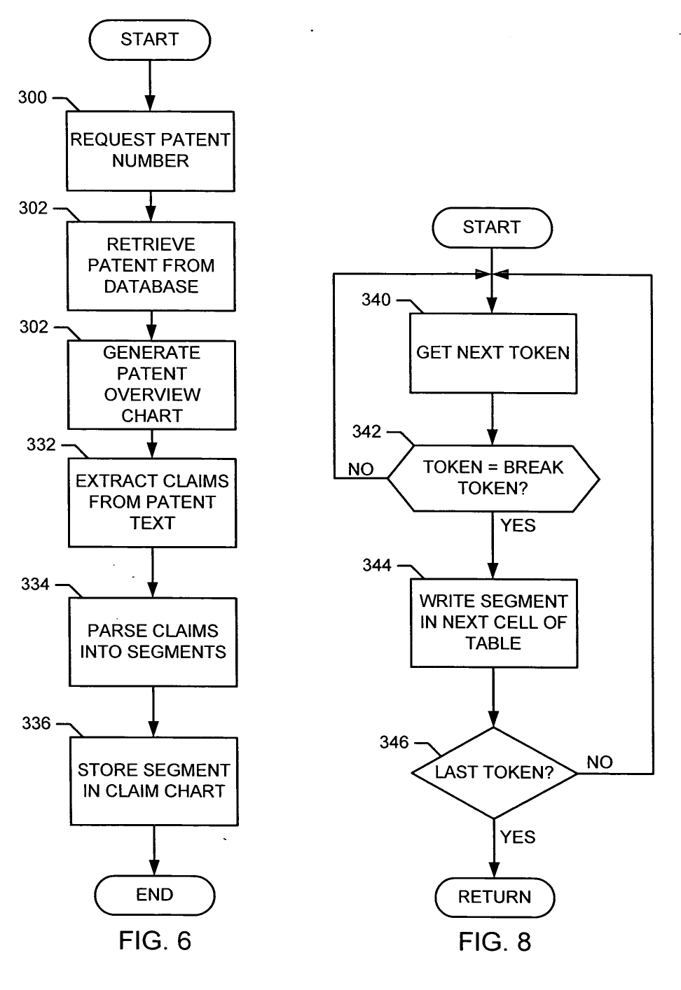

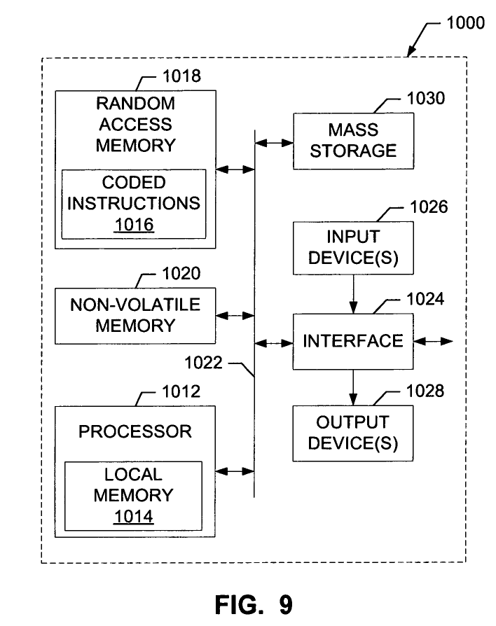

Flowcharts representative of example machine readable instructions for implementing the apparatus 10 of FIG. 1 are shown in FIGS. 6-8. In this example, the machine readable instructions comprise a program for execution by a processor such as the processor 1012 shown in the example computer 1000 discussed below in connection with FIG. 9, or by one or more processors associated with one ore more of the client 202, the server 204, or the server 208 of FIG. 4. The program may be embodied in software stored on a tangible medium such as a CD-ROM, a floppy disk, a hard drive, a digital versatile disk (DVD), or a memory associated with the processor 1012, but persons of ordinary skill in the art will readily appreciate that the entire program and/or parts thereof could alternatively be executed by a device other than the processor 1012 and/or embodied in firmware or dedicated hardware in a well known manner. For example, any or all of the interface 12, the patent retriever 16, the claim parser 20, the claim counter 24 and/or the chart generator 22 could be implemented by software, hardware, and/or firmware. Further, although the example program is described with reference to the flowcharts illustrated in FIGS. 6-8, persons of ordinary skill in the art will readily appreciate that many other methods of implementing the example apparatus 10 may alternatively be used. For example, the order of execution of the blocks may be changed, and/or some of the blocks described may be changed, eliminated, or combined.

The program of FIG. 6 begins at block 300 where, after housekeeping functions such as re-setting and/or initializing any counter(s), etc., the interface 12 is presented to a user to facilitate inputting a patent number. When a patent number is entered (block 300), the patent retriever 16 formulates an appropriate query and retrieves the patent data for the patent identified by the entered patent number from a database such as the database 210 (block 302).

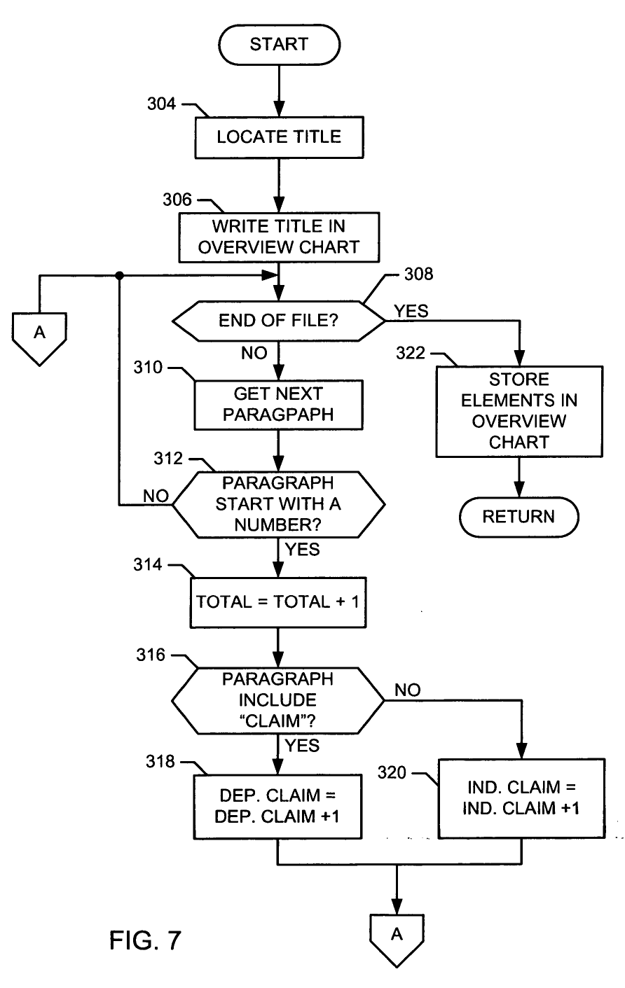

Upon receipt of the patent data (block 302), the apparatus 10 generates the patent overview chart from the patent data (block 304) by, for example, calling the example program shown in FIG. 7.

The program of FIG. 7 begins at block 304 where the apparatus 10 locates the title of the patent in the patent data retrieved at block 302. The apparatus 10 stores the title in the title field of the overview chart. Control then proceeds to the loop defined by blocks 308-322 to count the total number of claims, the number of dependent claims and the number of independent claims of the patent under analysis.

In particular, the claim counter 24 first determines whether every paragraph in the claims section of the patent have been reviewed (block 308). Assuming there is at least one claim in the patent that has not yet been analyzed (e.g., the end of file condition has not been reached) (block 308), control advances to block 310 where the next paragraph is obtained for examination. In the example of FIG. 7, if the paragraph starts with a number (block 312), it is identified as a claim and control advances to block 314. If, on the other hand, the paragraph does not start with a number (block 312), it is not identified as a claim and control returns to block 308 to determine if there are more possible claims to analyze. Persons of ordinary skill in the art will appreciate that some patents include paragraphs that begin with tokens including numbers that are not claims. For example, it is now common for the paragraphs of a US patent specification to be numbered with a number in brackets (e.g., [0010]). To avoid miscounting such numbered paragraphs as claims, the instructions represented by FIG. 7 may be modified such that paragraphs that begin with numbers within brackets are not counted as claims.

If at block 312, a numbered paragraph is identified, control advances to block 314 where the claim counter 24 increments a total claim counter by one. The claim counter 24 then examines the paragraph (i.e., the claim) at issue to determine if it includes the term “claim” (block 316). If the paragraph at issue includes the word “claim” (block 316), then the paragraph is identified as a dependent claim. (Persons of ordinary skill in the art will readily appreciate that a dependent claim is a claim that incorporates the recitations of another claim by reference). If the claim counter 24 identifies the paragraph as a dependent claim (block 316), the claim counter 24 increments a dependent claim counter (block 318). Control then returns to block 308 where the claim counter 24 determines if there are more possible claims to analyze.

If, on the other hand, claim counter 24 does not identify the paragraph as a dependent claim (block 316), the claim counter 24 increments an independent claim counter (block 320). Control then returns to block 308 where the claim counter 24 determines if there are more possible claims to analyze.

When the claim counter determines that there are no more possible claims to analyze (block 308), control advances to block 322. At block 322, the chart generator 22 populates a patent overview chart with the data generated by the claim counter 24. (An example patent overview chart is shown in FIGS. 3 and 5.) Control then returns to block 332 of FIG. 6.

At block 332, the claim parser 20 extracts the claim(s) (persons of ordinary skill in the art will appreciate that a patent may have one or more claims) from the patent text file. The claim parser 20 then parses the claim(s) into segments (block 334). The chart generator 22 then stores the segments in a claim chart (block 336). For example, the chart generator 22 may store the segments in a table and present that table to the user. The chart generator 22 may present the claim chart to the user using any method suitable for display of a claim chart. For example, the claim chart may be presented as an HTML formatted webpage, as an electronic mail message, as an ASCII plaintext document, as a table in a Rich Text Format (RTF) document, etc. Preferably, the claim chart is presented in a format that enables the user to edit, save, copy and/or print the claim chart.

FIG. 8 is a flowchart of example machine readable instructions which may be executed to parse the claim(s) of a patent into segments (e.g., to implement block 334 of FIG. 6). The example program of FIG. 8 begins by locating the first token (e.g., a number, word or character) of the claim(s) under analysis (block 340). The claim parser 20 is structured to identify the portion of a claim between any two of a set of predetermined tokens as a segment. Because segments (e.g., preamble, body, claim elements, and/or claim limitations) of claims of patents are typically divided by the tokens ‘comprising:’, ‘; and’ and ‘;’, these and possibly other tokens are identified as break tokens. Therefore, the claims parser compares the token identified at block 340 to the tokens in the set of break tokens (block 342). If a match does not occur (block 342), control returns to block 340 where the claim parser 20 obtains the next token.

If a match occurs (block 342), the claim parser 20 writes the portion of the claim ending at and including the current token (i.e., the token obtained at block 340) and beginning immediately after the last identified break token (if any) as a segment and writes that segment in the next empty cell of the claim chart (e.g., a table) (block 344). Control then advances to block 346 where the claim parser 20 determines if the last token has been reviewed. If not, control returns to block 340 where the claim parser 20 obtains the next token for analysis. If the last token has been reviewed (block 346), the claims parser 20 writes the remaining portion of the claim(s) not already written in a cell (if any) in the next empty cell and control returns to block 336 of FIG. 6.

Although certain tokens are identified above as example break tokens, persons of ordinary skill in the art will readily appreciate that other tokens may likewise be employed as break tokens. For example, a colon, a comma, a period, a line break, a hard return, a soft return, “consisting of:”, and/or other tokens may be identified as break tokens.

Attached hereto is the programming code for an example implementation of the described apparatus 10. This example implementation is written as a HTML interface connected to a Perl script to process the user instructions and server response. A person of ordinary skill in the art will recognize that some modules and libraries have not been provided in this listing of the code. These libraries include such modules as the RTF-Writer module and the LWP-Simple module. The modules and libraries that have not been included are commercially available libraries that are well known to persons of ordinary skill in art. The modules may, for example, be obtained from the Comprehensive Perl Archive Network (CPAN).

FIG. 9 is a block diagram of an example computer 1000 capable of implementing the apparatus and methods disclosed herein. The computer 1000 can be, for example, a server, a personal computer, a personal digital assistant (PDA), an Internet appliance, or any other type of computing device.

The system 1000 of the instant example includes a processor 1012 such as a general purpose programmable processor. The processor 1012 includes a local memory 1014, and executes coded instructions 1016 present in the local memory 1014 and/or in another memory device. The processor 1012 may execute, among other things, the example machine readable instructions illustrated in FIGS. 6-8. The processor 1012 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1012 is in communication with a main memory including a volatile memory 1018 and a non-volatile memory 1020 via a bus 1022. The volatile memory 1018 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1020 may be implemented by flash memory and/or any other desired type of memory device. Access to the main memory 1018, 1020 is typically controlled by a memory controller (not shown) in a conventional manner.

The computer 1000 also includes a conventional interface circuit 1024. The interface circuit 1024 may be implemented by any type of well known interface standard, such as an Ethernet interface, a universal serial bus (USB), and/or a third generation input/output (3GIO) interface.

One or more input devices 1026 are connected to the interface circuit 1024. The input device(s) 1026 permit a user to enter data and commands into the processor 1012. The input device(s) can be implemented by, for example, a keyboard, a mouse, a touchscreen, a track-pad, a trackball, isopoint and/or a voice recognition system.

One or more output devices 1028 are also connected to the interface circuit 1024. The output devices 1028 can be implemented, for example, by display devices (e.g., a liquid crystal display, a cathode ray tube display (CRT), a printer and/or speakers). The interface circuit 1024, thus, typically includes a graphics driver card.

The interface circuit 1024 also includes a communication device (e.g., communication device 14) such as a modem or network interface card to facilitate exchange of data with external computers via a network (e.g., an Ethernet connection, a digital subscriber line (DSL), a telephone line, coaxial cable, a cellular telephone system, etc.).

The computer 1000 also includes one or more mass storage devices 1030 for storing software and data. Examples of such mass storage devices 1030 include floppy disk drives, hard drive disks, compact disk drives and digital versatile disk (DVD) drives. The mass storage device 1030 may implement the database 210.

From the foregoing, persons of ordinary skill in the art will readily appreciate that various modifications can be made to the example apparatus 10 of FIGS. 1 and/or 4, and/or to the example machine readable instructions of FIGS. 6-8. For instance, the apparatus 10 and/or the machine readable instructions may be modified to require payment of a fee by, for example, submission of a credit card number and subsequent billing of the associated credit card account, before generating a claim chart. Thus, for example, although the illustrated apparatus 10 automatically generates a clam chart upon receipt of a patent number (and possibly a user name and/or password), it will be understood that automatically generating a claim chart could exclude or include additional user interactions such as requests for additional information (e.g., a credit card number) and/or user inputs. Additionally or alternatively, the example apparatus 10 and/or the example machine readable instructions discussed above could be modified to enable the user to specify the tokens to be used in parsing a claim and/or other parameters such as the number of columns to be included in the claim chart (e.g., 1, 2, 3, etc.).

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

### COPYRIGHT NOTICE AND PERMISSION

A portion of the disclosure of this patent document and/or its file history contains material that is subject to copyright protection (e.g., the appended programming code). The copyright owner has no objection to the facsimile reproduction by anyone of the patent document or its file history, as it appears in the United States Patent and Trademark Office patent files or records, but otherwise reserves all rights under the applicable copyright laws. The following notice shall apply to this patent document and its file history (including the programming code): Copyright© 2003, Hanley, Flight & Zimmerman, LLC.

What is claimed is:

1. A method of generating a patent claim chart comprising:
receiving an input identifying a patent via a user interface; and
automatically generating a claim chart containing at least one claim of the identified patent.

2. A method as defined in claim 1 wherein the input comprises a patent number.

3. A method as defined in claim 1 wherein the user interface is a web page.

4. A method as defined in claim 1 wherein automatically generating a claim chart further comprises
retrieving an electronic file representing at least a portion of the identified patent;
electronically identifying the at least one claim within the file;
automatically parsing the claim into at least two portions; and
locating the at least two portions in at least two different cells of a table.

5. A method as defined in claim 4 wherein retrieving the electronic file representing at least the portion of the identified patent comprises retrieving the electronic file from an on-line database.

6. A method as defined in claim 5 wherein the on-line database comprises at least one of a commercial database, a public database, or a database of the United States Patent & Trademark Office.

7. A method as defined in claim 4 wherein retrieving the electronic file representing at least the portion of the identified patent comprises retrieving the electronic file from a local database.

8. A method as defined in claim 4 wherein electronically identifying the at least one claim within the file further comprises searching the electronic file for a paragraph beginning with a number.

9. A method as defined in claim 8 wherein searching the electronic file for a paragraph beginning with a number comprises searching for a number which is not surrounded by brackets.

10. A method as defined in claim 4 wherein automatically parsing the claim into at least two portions comprises:
searching the at least one claim for at least one token;
identifying a portion of the claim before the at least one token as a first one of the at least two portions; and
identifying a portion of the claim after the at least one token as a second one of the at least two portions.

11. A method as defined in claim 10 wherein the token comprises at least one of “;”, “; and”, “comprising:”, “,”, “of:”, “:”, “consisting of:”, or “steps of”.

12. A method as defined in claim 4 wherein locating the at least two portions in at least two different cells of a table further comprises:
associating a first one of the at least two portions with a first cell in a first column of the table; and
associating a second one of the at least two portions with a second cell in the first column of the table.

13. A method as defined in claim 12 wherein the second cell is below the first cell.

14. A method as defined in claim 12 further comprising creating a second column adjacent the first column, the cells of the second column being empty.

15. A method as defined in claim 1 wherein outputting the claim chart comprises outputting at least one of an RTF file, a Word file, an HTML page, an email message, or an ASCII plaintext document.

16. A method as defined in claim 1 wherein automatically generating a claim chart further comprises at least one of a user prompt and/or a second user input.

17. A method as defined in claim 1 wherein automatically generating a claim chart further comprises requesting payment information before generating the claim chart.

18. A method as defined in claim 1 wherein the input is the only input needed to generate the claim chart.

19. A method of generating a claim chart comprising:
receiving an input identifying at least one patent via a user interface;
retrieving the patent from a database of documents;
automatically parsing a claim of the patent into at least two components;
outputting a table having first and second columns, the first column containing the two components, the second column including at least one empty cell.

20. An apparatus to create a claim chart comprising:
an interface to receive an input identifying a patent;
a patent retriever to retrieve the patent from a database;
a claim parser to divide at least one claim of the patent into segments; and
a chart generator to create a claim chart containing the segments.

21. An apparatus as defined in claim 20 further comprising a claim counter to determine a number of claims in the at least one patent.

22. An apparatus as defined in claim 21 wherein the claim counter determines a number of dependent claims and a number of independent claims in the patent.

23. An apparatus as defined in claim 20 further comprising a communication device communicatively coupling the patent retriever to the database.

24. An apparatus as defined in claim 20 further comprising an output device to output the claim chart.

25. An apparatus as defined in claim 20 wherein the interface is a web interface and the input is a patent number.

26. An apparatus as defined in claim 20 wherein the interface is password protected.

27. An apparatus as defined in claim 20 wherein the claim parser divides the claims based upon one or more predetermined token in the claim.

28. An apparatus as defined in claim 27 the one or more predetermined token comprise at least one of “;”, “; and” or “comprising:”, “:”, “,”, “of:”, “:”, “consisting of:”, or “steps of”.

29. An apparatus as defined in claim 20 wherein the chart generator places each segment in a respective cell.

30. An apparatus as defined in claim 20 wherein each segment corresponds to at least one of: a claim preamble, a claim body, one or more claim limitation, or one or more claim element.

31. An article of manufacture which, when executed, causes a machine to:
receive an input identifying a patent via a user interface; and
automatically generate a claim chart containing at least one claim of the identified patent.

32. A method of generating a patent claim chart comprising:
retrieving an electronic file representing at least a portion of an identified patent;
identifying at least one claim within the file;
comparing a token of the at least one claim to at least one break token stored in a memory to parse the claim into at least two segments; and
locating the at least two segments in at least two different portions of a claim chart.
